(19) United States
(12) Patent Application Publication
(10) Pub. No.: US 2010/0091047 A1
(43) Pub. Date: Apr. 15, 2010

(54) LIGHT EMITTING DEVICE, DISPLAY DEVICE USING THE SAME, AND DRIVING METHOD OF DISPLAY DEVICE

(76) Inventor: Byong-Gon Lee, Suwon-si (KR)

Correspondence Address: CHRISTIE, PARKER & HALE, LLP, PO BOX 7068, PASADENA, CA, 91109-7068, US

(21) Appl. No.: 12/579,172

(22) Filed: Oct. 14, 2009

(30) Foreign Application Priority Data
Oct. 14, 2008 (KR) 10-2008-0100724

(51) Int. Cl. G09G 5/10; H01J 61/94; G09F 13/08

(52) U.S. Cl. 345/690; 313/1; 362/97.1

(57) ABSTRACT

A light emitting device includes a plurality of light emission scan lines for transmitting light emission scan signals, a plurality of light emission data lines for transmitting light emission data voltages, a plurality of light emitting pixels for emitting electrons according to differences between an on voltage and the light emission data voltages, and first and second deflection electrodes. The light emission scan lines extend in a first direction, the light emission data lines extend in a second direction that crosses the light emission scan lines. The light emitting pixels are at areas defined by the light emission scan lines and the light emission data lines. The first and second deflection electrodes are parallel with each other in the first direction between the light emitting pixels. An absolute value of a first voltage applied to the first deflection electrode and an absolute value of a second voltage applied to the second deflection electrode are set according to a deflection direction of the electrons.

### CROSS-REFERENCE TO RELATED APPLICATION

This application claims priority to and the benefit of Korean Patent Application No. 10-2008-0100724 filed in the Korean Intellectual Property Office on Oct. 14, 2008, the entire content of which is incorporated herein by reference.

### BACKGROUND

1. Field

The described technology relates generally to a light emitting device, a display device having the same, and a driving method thereof.

2. Description of the Related Art

Flat panel displays, such as liquid crystal displays (LCDs), are display devices that display images by varying the amount of transmitted light for pixels using dielectric anisotropy of liquid crystal in which a twist angle varies according to an applied voltage.

The liquid crystal display generally includes a liquid crystal panel assembly and a light emitting device which is provided at a rear side of the liquid crystal panel assembly and supplies light to the liquid crystal panel assembly. One pixel of the light emitting device may be formed of a field emission array (FEA) type of electron emitting device.

The electron emitting device may be driven by a constant voltage pulse having a predetermined duty ratio. This electron emitting device may have an electron emission non-uniformity phenomenon in which an electron beam is not uniformly spread between electron emission devices due to structural factors such as processes or materials.

An electron emitting device may be driven by a constant voltage pulse applied to three electrodes, for example, a gate electrode, a cathode, and an anode. Here, the three electrodes are separated from each other for driving, and electron emitting units that include the electron emitting devices are discontinuously arranged.

When a predetermined driving voltage is applied to the cathode and the gate electrode, electron beams emitted from the electron emitting unit are attracted by the anode to which a high voltage is applied and collide against a phosphor layer. Here, if the electron beams are not spread sufficiently, electron emission non-uniformity may occur due to electron beams that do not uniformly impact on the phosphor layer.

A light emitting pixel of the light emitting device may correspond to a predetermined number of display pixels of a display panel, and therefore, the number of light emission scan lines of the light emitting device may be less than the number of display scan lines of the LCD. Accordingly, each light emission scan line may correspond to more than one display scan line of the LCD.

The above information disclosed in this Background section is only for enhancement of understanding of the background of the invention and therefore it may contain information that does not form the prior art that is already known in this country to a person of ordinary skill in the art.

### SUMMARY

The described technology provides a light emitting device that can uniformly spread electron beams and prevent luminance non-uniformity, a display device having the same, and a driving method thereof.

According to an exemplary embodiment of the present invention, a light emitting device is provided. The light emitting device includes a plurality of light emission scan lines extending in a first direction, a plurality of light emission data lines extending in a second direction that crosses the plurality of light emission scan lines, a plurality of light emitting pixels at areas defined by the plurality of light emission scan lines and the plurality of light emission data lines, and first and second deflection electrodes parallel with each other in the first direction between the plurality of light emitting pixels. The light emission scan lines are for transmitting light emission scan signals. The light emission data lines are for transmitting light emission data voltages. The light emitting pixels are for emitting electrons according to differences between an on voltage of the light emission scan signals and the light emission data voltages. An absolute value of a first voltage applied to the first deflection electrode and an absolute value of a second voltage applied to the second deflection electrode are set according to a deflection direction of the electrons.

According to another exemplary embodiment of the present invention, a display device is provided. The display device includes a display panel and a light emitting device. The display panel includes a plurality of display scan lines extending in a first direction and for transmitting display scan signals, a plurality of display data lines extending in a second direction that crosses the plurality of display scan lines and for transmitting display data signals, and a plurality of display pixels at areas defined by the plurality of display scan lines and the plurality of display data lines. The light emitting device includes a plurality of light emission scan lines extending in the first direction and for transmitting light emission scan signals, a plurality of light emission data lines extending in the second direction and for transmitting light emission data voltages, a plurality of light emitting pixels at areas defined by the plurality of light emission scan lines and the plurality of light emission data lines and for emitting electrons according to differences between an on voltage of the light emission scan signals and the light emission data voltages, and first and second deflection electrodes parallel with each other in the first direction between the plurality of light emitting pixels. An absolute value of a first voltage applied to the first deflection electrode and an absolute value of a second voltage applied to the second deflection electrode are set according to a deflection direction of the electrons. A light emission scan line of the plurality of light emission scan lines corresponds to a group of a predetermined number of display scan lines of the plurality of display scan lines.

According to yet another exemplary embodiment of the present invention, a driving method of a display device is provided. The display device includes a plurality of first electrodes extending in a first direction and for transmitting first signals comprising combinations of an on voltage and an off voltage, a plurality of second electrodes insulated from and crossing the first electrodes and for transmitting light emission data voltages, a plurality of electron emission units at crossing areas of the plurality of first electrodes and the plurality of second electrodes, and first and second deflection electrodes parallel with each other in the first direction between the plurality of electron emission units. The driving method includes transmitting the on voltage to at least one first electrode of the plurality of first electrodes; transmitting a light emission data voltage of the light emission data voltages to at least one of the plurality of second electrodes; while the on voltage is applied to the at least one first electrode, setting an absolute value of a first voltage applied to the first deflection electrode and an absolute value of a second voltage applied to the second deflection electrode; emitting electrons according to a difference between the on voltage and the light emission data voltage; and deflecting the electrons by using the absolute values of the first and second voltages.

As described, according to the present invention, electron beams of a light emitting device can be uniformly spread. In addition, electron beams can be directed corresponding to a scan sequence of an LCD that is backlit by the light emitting device. Accordingly, luminance non-uniformity of the LCD can be prevented, thereby improving luminous efficiency.

### BRIEF DESCRIPTION OF THE DRAWINGS

FIG. 1 is a schematic diagram of a display device according to an exemplary embodiment of the present invention.

FIG. 2 is a block diagram of a light emitting device in the display device of FIG. 1.

FIG. 3 is a partial cross-sectional view of a light emission unit of the light emitting device of FIG. 2.

FIG. 4 is a partial cross-sectional view of the light emission unit of FIG. 3, taken along the line IV-IV′.

FIG. 5 shows deflection of an electron beam in the light emission unit of FIG. 3.

FIG. 6 shows light emitting periods for a plurality of light emitting pixels formed in each row of a plurality of rows of the light emission unit of FIG. 3.

FIG. 7 schematically shows a driving voltage of the light emission unit of FIG. 3.

FIG. 8A to FIG. 8E show examples of different deflections of electron beams to an anode that correspond to the light emitting periods according to the driving voltage of FIG. 7.

FIG. 9 shows a partial cross-sectional view of a light emission unit of a light emitting device according to another exemplary embodiment of the present invention.

FIG. 10 shows a partial cross-sectional view of the light emission unit of FIG. 9, taken along the line IX-IX′.

FIG. 11 schematically shows a driving voltage of the light emission unit of FIG. 9.

FIG. 12 shows deflection of an electron beam in the light emission unit of FIG. 9.

FIG. 13 is a block diagram of a liquid crystal display (LCD) according to an exemplary embodiment of the present invention.

FIG. 14 is an equivalent circuit diagram of one display pixel in the LCD of FIG. 13.

FIG. 15 shows a time point of light supply when a conventional light emitting device is used as a light source.

FIG. 16 shows a time point of light supply according to deflection of electron beams when the light emitting device according to an exemplary embodiment of the present invention is used as a light source.

### DETAILED DESCRIPTION

In the following detailed description, certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

Hereinafter, a light emitting device and a display device using the same will be described in further detail.

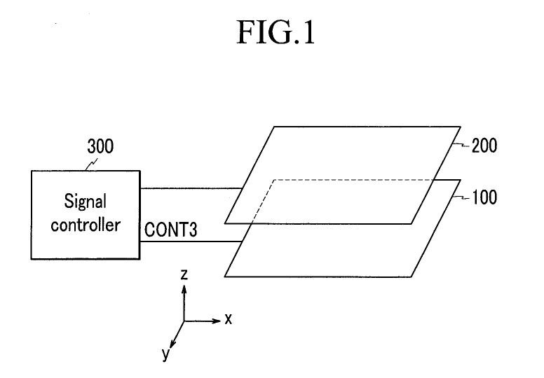

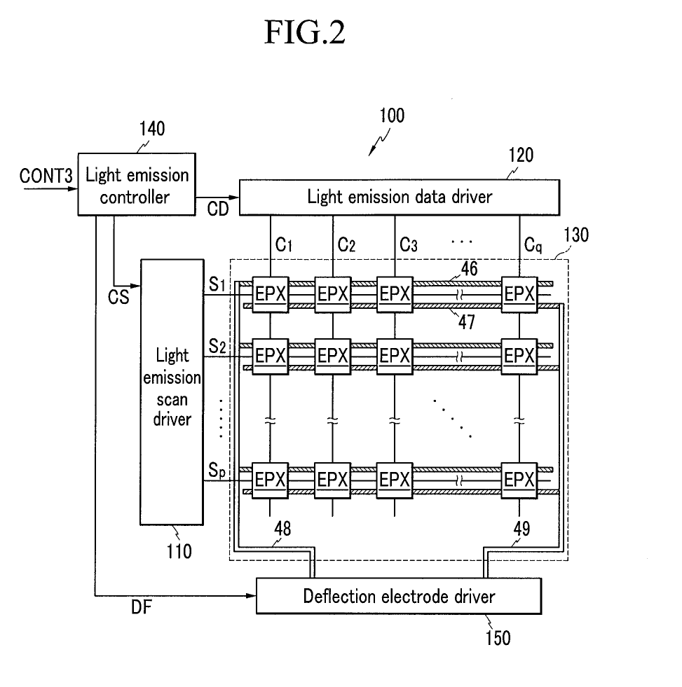

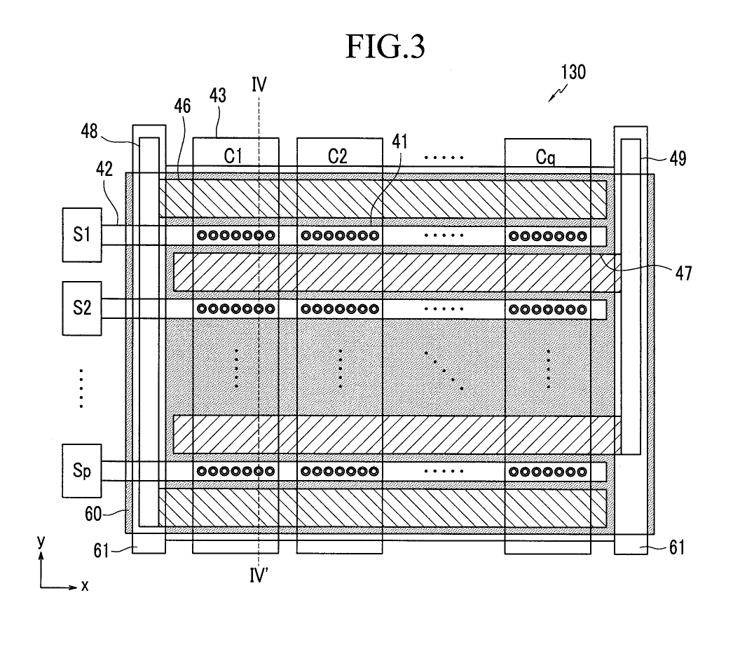

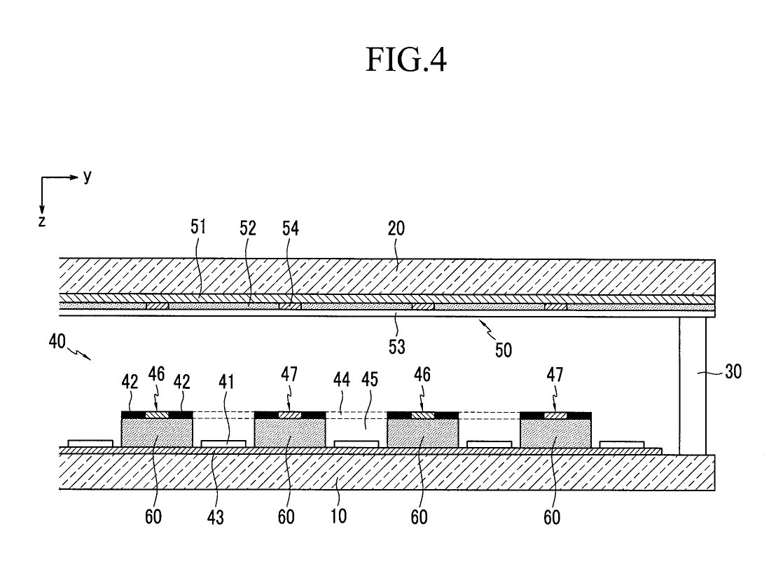

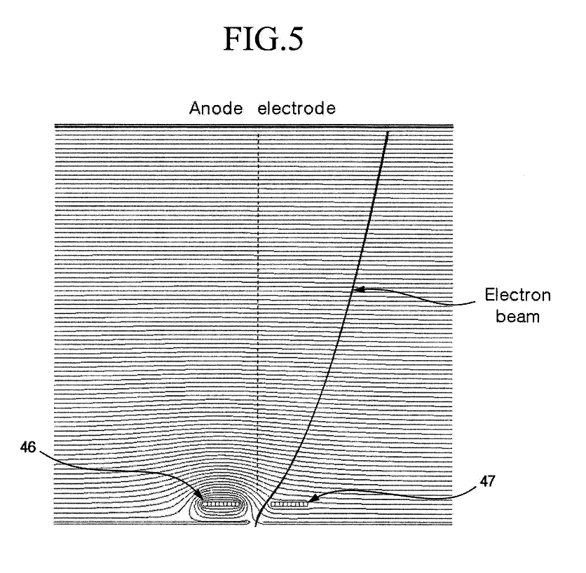

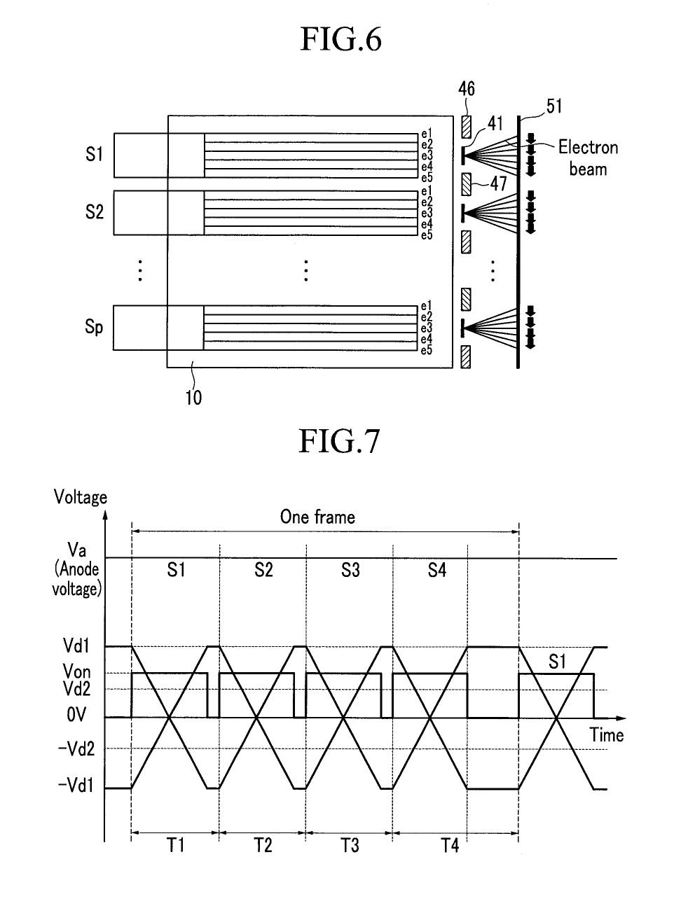

FIG. 1 is a schematic diagram of a display device according to an exemplary embodiment of the present invention, and FIG. 2 is a block diagram of a light emitting device of the display device of FIG. 1. FIG. 3 shows a partial cross-sectional view of a light emission unit of the light emitting device of FIG. 2, and FIG. 4 shows a partial cross-sectional view of the light emission unit of FIG. 3, taken along the line IV-IV′. FIG. 5 shows deflection of an electron beam of the light emission unit of FIG. 3, and FIG. 6 shows light emitting periods of a plurality of light emitting pixels formed in each row of a plurality of rows of the light emission unit of FIG. 3.

Referring to FIG. 1, the display device according to an exemplary embodiment of the present invention includes a display unit 200 (such as an LCD), a light emitting device 100, and a signal controller 300. The display unit 200 and the light emitting device 100 are disposed in parallel and controlled by the signal controller 300. The display unit 200 displays an image by using light provided from the light emitting device 100. The display unit 200 includes a plurality of display pixels (not shown) arranged substantially in a matrix format.

Referring to FIG. 2, the light emitting device 100 includes a light emission scan driver 110, a light emission data driver 120, a light emission unit 130, a light emission controller 140, and a deflection electrode driver 150.

In an equivalent circuit view, the light emission unit 130 includes a plurality of light emission signal lines S₁ to Sₚ and C₁ to C_{q}, and a plurality of light emitting pixels EPX connected to the plurality of light emission signal lines S₁ to Sₚ and C₁ to C_{q} and arranged substantially in a matrix format.

The light emission signal lines S₁ to Sₚ and C₁ to C_{q} include a plurality of light emission scan lines S₁ to Sₚ that transmit light emission scan signals, and a plurality of light emission data lines C₁ to C_{q} that transmit light emission data voltages. The plurality of light emission scan lines S₁ to Sₚ extend substantially in a row (first) direction and substantially parallel with each other, and the plurality of light emission data lines C₁ to C_{q} extend substantially in a column (second) direction that crosses the row direction and substantially parallel with each other.

Each light emitting pixel EPX may correspond to a predetermined number of display pixels of the display unit 200. That is, one light emitting pixel EPX may correspond to N×M display pixels defined by N rows and M columns. Here, N and M may each be integers greater than 1.

For example, when 1024 display pixels are in the row direction and 768 display pixels are in the column direction in the display unit 200 and N and M are each 4, then 256 light emitting pixels EPX are in the row direction and 192 light emitting pixels EPX are in the column direction in the light emission unit 130 and one light emitting pixel EPX may correspond to 16 display pixels.

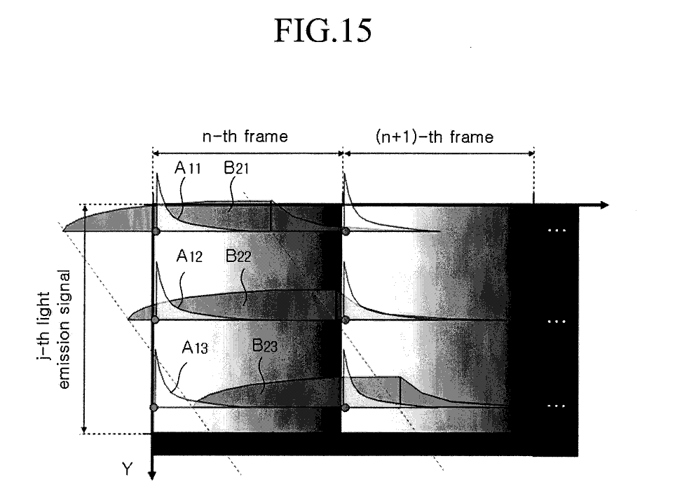

When N>1 (that is, there are multiple display rows corresponding to each light emitting row), the difference between operation of the light emitting device and the LCD may cause mismatching of the time that light is emitted from a light emitting row and the time that light is transmitted by operation of the liquid crystal of the corresponding display rows so that luminance non-uniformity can occur. For example, when a display pixel on the display panel changes from color to black, light may first be emitted from the corresponding light emitting pixel and then the liquid crystal of the display pixel responds thereto for displaying black. Thus, light emitted from the light emitting pixel is partially transmitted at the initial stage of the black display pixel so that luminance non-uniformity occurs. This phenomenon is demonstrated for a conventional light emitting device in FIG. 15, where N=3 and B₂₁, B₂₂, and B₂₃ represent the difference between 3 display pixel rows corresponding to the same light emitting row (j-th light emission signal) represented by the n-th frame. As can be seen, while the liquid crystal corresponding to B₂₁ responds fast enough to block the light from transmitting and display black, the liquid crystal corresponding to B₂₃ responds too late to block the light from transmitting and causing luminance non-uniformity.

Referring to FIG. 3 and FIG. 4, the light emission unit 130 includes two substrates 10 and 20 that face each other, and a sealing member 30 interposed therebetween that seals them. In this embodiment, a vacuum chamber is formed by the substrates 10 and 20 and the sealing member 30, and an internal space is maintained with a vacuum at 10⁻⁶ Torr.

The region of the two substrates 10 and 20 located within the sealing member 30 is divided into a valid region (display region) that substantially contributes visible light emission and an invalid region (non-display region) that surrounds the valid region. A plurality of electron emitting units 40 for electron emission are located in the valid region on the substrate 10, and a light emitting unit 50 for visible light emission is located in the valid region on the substrate 20.

The substrate 20 where the light emitting unit 50 is located may be set as a front substrate of the light emission unit 130, and the substrate 10 where the electron emitting units 40 are located may be set as a rear substrate of the light emission unit 130.

On the substrate 10, a plurality of driving electrodes 42 and 43 (first and second electrodes) are formed. Each electron emitting unit 40 includes an electron emission unit 41 and a part of the driving electrodes 42 and 43. The driving electrodes 42 and 43 control an electron emission amount of the electron emission unit 41. The plurality of driving electrodes 42 and 43 include a plurality of gate electrodes 42 extending in the x-axis direction and a plurality of cathodes 43 extending in the y-axis direction. The cathode 43 extends in a direction that crosses the gate electrode 42 under the gate electrode 42. An insulation layer 60 is interposed between the cathode 43 and the gate electrode 42. In this embodiment, in the light emitting device 100, the plurality of gate electrodes 42 respectively form the plurality of light emission scan lines S₁ to Sₚ, and the plurality of cathodes 43 respectively form the plurality of light emission data lines C₁ to C_{q}. In other embodiments, the plurality of cathodes 43 may respectively form the plurality of light emission scan lines S₁ to Sₚ, and the plurality of gate electrodes 42 may respectively form the plurality of light emission data lines C₁ to C_{q}.

At every crossing area of the gate electrode 42 and the cathode 43, openings 44 and 45 are formed respectively in the gate electrode 42 and the insulation layer 60 to partially expose the surface of the cathode 43. In this embodiment, the electron emission unit 41 is located on the cathode 43 within the openings 44 and 45.

In addition, the light emission unit 130 further includes insulation layers 60 and 61 that cover the cathodes 43, and deflection electrodes 46 and 47 (first and second deflection electrodes) formed on the insulation layers 60 and 61. The deflection electrodes 46 and 47 are disposed in the row direction, with the electron emission units 41 located between them. In addition, the deflection electrodes 46 and 47 connect to voltage applying units 48 and 49, respectively, that are disposed opposite to each other, and receive a voltage for deflection of an electron beam from the voltage applying units 48 and 49. In this embodiment, the voltage applying units 48 and 49 extend in the y-axis direction.

The electron emission unit 41 is formed of materials, for example a carbon-based material or a nanometer-sized material, which emit electrons when an electric field is applied in a vacuum state. The electron emission unit 41 may be formed of a material selected from the group of carbon nanotubes, graphite, graphite nanofibers, diamond, diamond-like carbon, fullerene (C₆₀), silicon nanowires, and combinations thereof, or may be formed as a structure having a sharp tip and made of molybdenum (Mo) or silicon (Si), etc.

One crossing area of the gate electrode 42 and the cathode 43 may correspond to one light emitting pixel EPX of the light emission unit 130. In other embodiments, two or more crossing areas may correspond to one light emitting pixel EPX of the light emission unit 130.

The light emitting unit 50 includes an anode 51, a phosphor layer 52 formed on one side of the anode 51, and a metal reflective layer 53 that covers the phosphor layer 52. The anode 51 receives an anode voltage from a power source (not shown) at an external side of the vacuum chamber, and maintains the phosphor layer 52 in a high potential state. The anode 51 may be formed as a transparent conductive layer such as indium tin oxide (ITO) for transmitting visible light emitted from the phosphor layer 52.

The metal reflective layer 53 may be formed of aluminum with a thickness of, for example, several thousand angstroms (Å). The metal reflective layer 53 includes micro-holes for transmission of electron beams. The metal reflective layer 53 reflects visible light that is emitted toward the substrate 10. This reflected light combines with the visible light emitted from the phosphor layer 52 toward the substrate 20 to thereby increase luminance of a light emitting surface thereof. In other embodiments, the anode 51 may be omitted, and the metal reflective layer 53 may receive the anode voltage and function as the anode.

The light emitting unit 50 further includes a dark-colored layer 54 formed of chromium. In this embodiment, the phosphor layer 52 is formed on the anode 51 in positions that correspond to areas where the electron emitting units 40 are formed. In addition, the dark-colored layer 54 is formed between neighboring phosphor layers 52, that is, in positions that correspond to areas where the electron emission units 40 are not formed. In other embodiments, the phosphor layer 52 may cover the entire anode 51.

In the valid region between the two substrates 10 and 20, a plurality of spacers (not shown) may be formed for supporting against a compression force applied to the vacuum chamber and maintaining a distance between the two substrates 10 and 20. In this embodiment, when a difference between a driving voltage applied to the gate electrode 42 and a driving voltage applied to the cathode 43 is greater than a threshold value, an electric field is formed around the electron emission unit 41 and electrons are emitted therefrom. The emitted electrons are attracted by an anode voltage, for example a positive voltage having several thousand volts that is applied to the anode 51, and then collide against a corresponding phosphor layer 52 to emit light. The light emission intensity of the phosphor layer 52 corresponds to the amount of electron beam emission.

Referring back to FIG. 2, the light emission controller 140 generates a light emission scan control signal CS, a light emission data control signal CD, and a deflection control signal DF based on a light emission control signal CONT3 from the controller 300, and controls the light emission scan driver 110, the light emission data driver 120, and the deflection electrode driver 150.

The light emission scan driver 110 is connected to the light emission scan lines S₁ to Sₚ of the light emission unit 130, and sequentially applies a light emission scan signal to the light emission scan lines S₁ to Sₚ according to the light emission scan control signal CS transmitted from the light emission controller 140. The light emission scan signals are formed of a combination of a light emission ON voltage Von and a light emission OFF voltage Voff.

The light emission data driver 120 is connected to the light emission data lines C₁ to C_{q} of the light emission unit 130, and generates a plurality of light emission data voltages to be applied to the plurality of light emission data lines C₁ to C_{q} according to the light emitting data control signal CD of the light emission controller 140 and transmits the light emission data voltages to the light emission data lines C₁ to C_{q}. Each light emission data voltage may be a positive voltage that is lower than the light emission on-voltage Von, or a negative voltage.

For each light emitting pixel EPX, which corresponds to a predetermined number of display pixels PX, each of which has a corresponding gray level to display, the light emission data driver 120 can select one of the plurality of voltages corresponding to a representative gray level of the display pixels PX, and can set the selected voltage as a light emission data voltage. Then, the light emitting pixel EPX emits light with luminance that corresponds to the representative gray level. In this embodiment, the representative gray level may be the highest gray level among the gray levels to be displayed by the corresponding display pixels PX.

In other embodiments, the light emission data voltages may have a constant level without regard to input video signals R, G, and B input to the signal controller 300. Then, the light emitting pixel EPX emits light with constant luminance without regard to the gray levels to be displayed by the corresponding display pixels PX.

The deflection electrode driver 150 is connected to the deflection electrodes 46 and 47 located between the light emitting pixels EPX and the voltage applying units 48 and 49 applying voltages to the deflection electrodes 46 and 47, and controls voltages applied to the deflection electrodes 46 and 47 according to the deflection control signal DF from the light emission controller 140. In this embodiment, the voltages applied to the deflection electrodes 46 and 47 are set according to a deflection direction of the electron beam emitted from the electron emission unit 41, and absolute values thereof are the same (or substantially the same).

Light emission operation of the light emitting device 100 will now be described in further detail.

Referring back to FIG. 2 and FIG. 3, the light emission data driver 120 generates light emission data voltages that correspond to light emitting pixels EPX of one row according to the light emitting data control signal CD from the light emission controller 140, and applies the light emission data voltages to the light emission data lines C₁ to C_{q}.

The light emission scan driver 110 sequentially applies the light emission ON voltage Von to each of the light emission scan lines S₁ to Sₚ according to the light emitting scan control signal CS from the light emission controller 140. Then, electron beams are emitted from the corresponding electron emission units 41 due to voltage differences between the light emission data voltages applied to the light emission data lines C₁ to C_{q}, that is, to the cathodes 43, and the light emission ON voltage Von applied to the light emission scan lines S₁ to Sₚ, that is, to the gate electrodes 42. The emitted electron beams collide with the phosphor layer 52 so that the light emitting pixels EPX emit light.

In this embodiment, the deflection electrode driver 150 controls the deflection voltages applied to the deflection electrodes 46 and 47 that are adjacent to the light emission scan lines S₁ to Sₚ according to the deflection control signal DF from the light emission controller 140. Then, the electron beams emitted from the electron emission units 41 are deflected in the direction of an electrode, for example the deflection electrode 47 to which a positive deflection voltage is applied, due to a potential difference of the deflection voltages applied to the deflection electrodes 46 and 47, as shown in FIG. 5.

The deflection electrode driver 150 controls the voltage of each of the deflection electrodes 46 and 47 that are adjacent to the light emission scan lines S₁ to Sₚ to which the light emission ON voltage Von is applied. This takes place during each light emission scan period for which the light emission ON voltage Von is applied to the light emission scan lines S₁ to Sₚ in order to control the electron beams emitted from the electron emission units 41. This causes the emitted electron beams to be sequentially deflected to the anode 51 with deflections that correspond to light emitting periods, where each light emission scan period is divided into at least one light emitting period, for example, light emitting periods e1 to e5 as shown in FIG. 6. For instance, each light emitting period (and corresponding deflection) of a light emission scan period for one light emitting row may correspond to a different display row (and its corresponding display scan period) of the corresponding display rows for the light emitting row. For example, FIG. 6 may represent such a scheme with N=5 (that is, 5 display rows that correspond to each light emitting row), so each light emitting period e1 to e5 (and its corresponding deflection) applies to one of the 5 corresponding display scan periods (and its corresponding display row).

Through repetition of the above process, all light emitting pixels EPX emit light by sequentially applying the light emission ON voltage Von to all the light emission scan lines S₁ to Sₚ and applying the light emission data voltages to the light emitting pixels EPX to thereby supply light to a display panel 210.

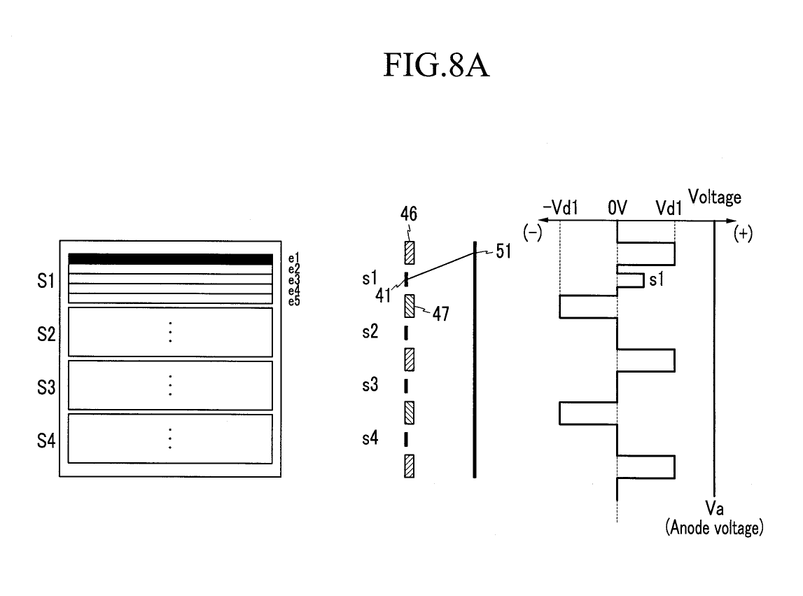

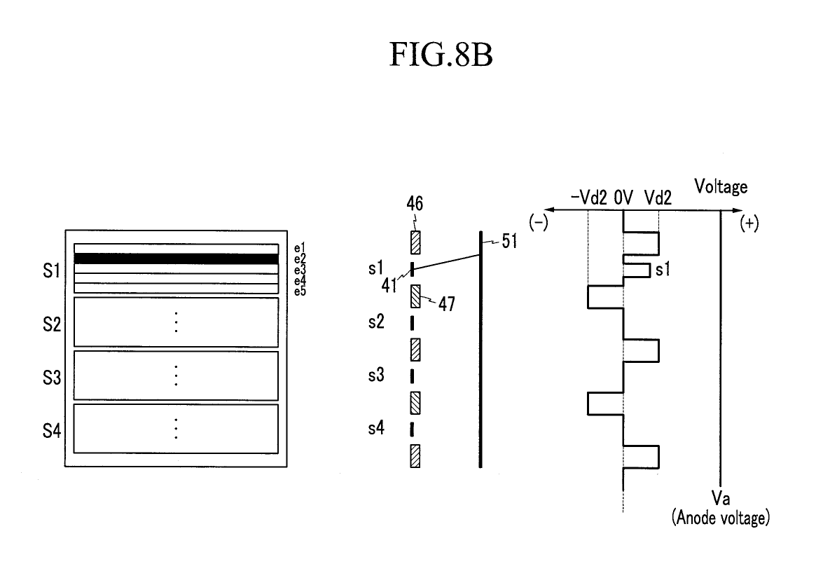

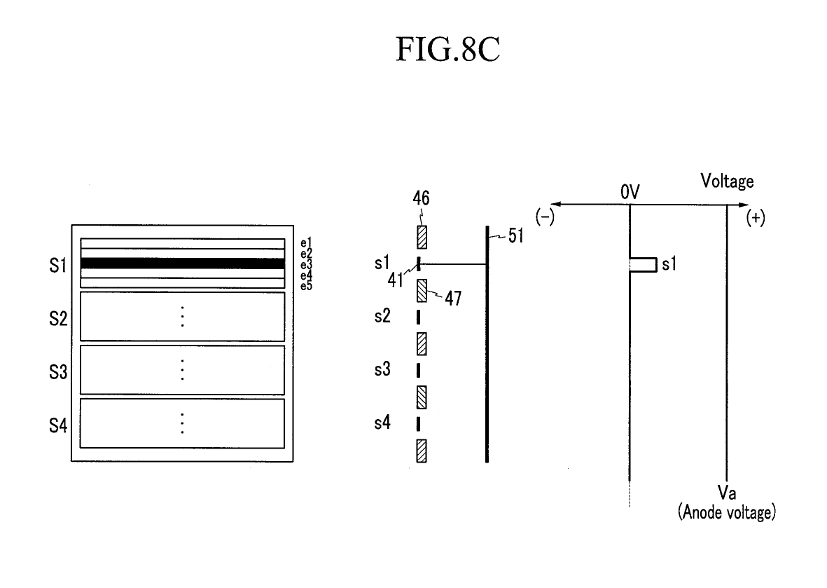

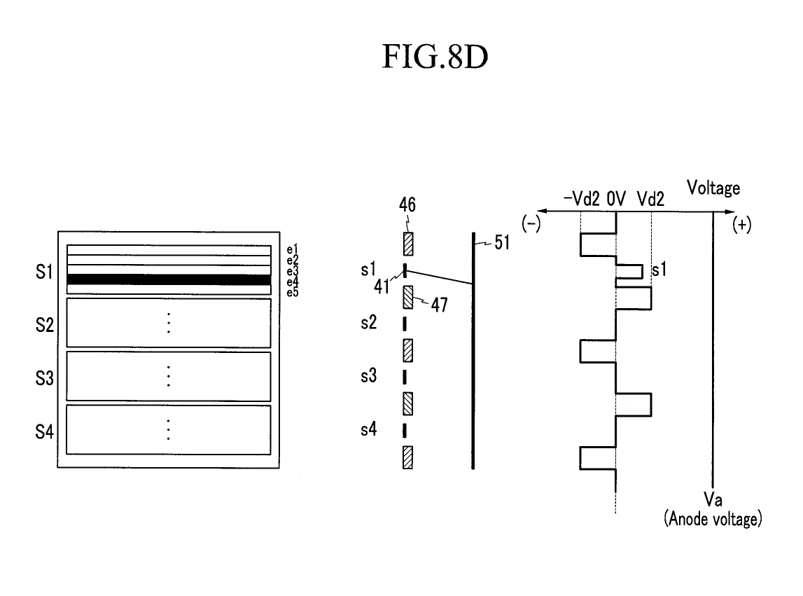

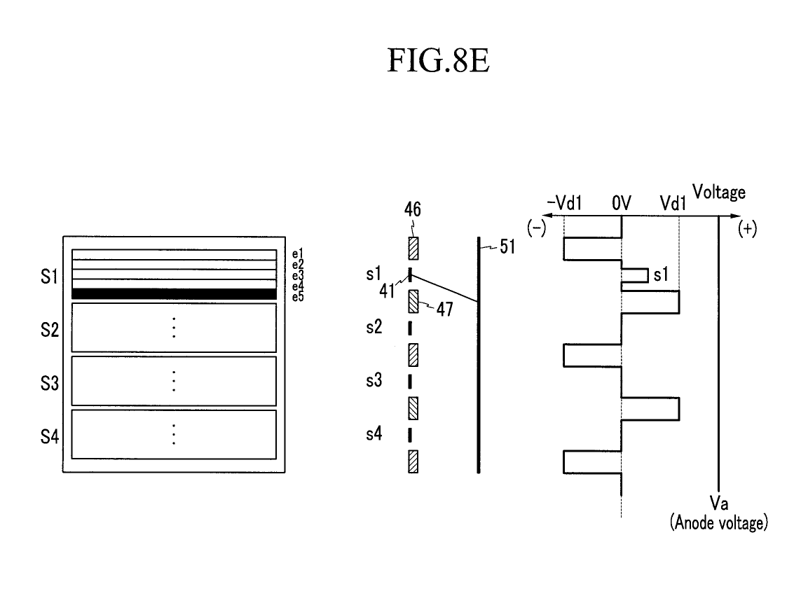

Hereinafter, a method for preventing non-uniformity of luminance according to an exemplary embodiment of the present invention will be described with reference to FIG. 7 and FIG. 8A to FIG. 8E.

FIG. 7 schematically shows a driving voltage of the light emission unit of FIG. 3, and FIG. 8A to FIG. 8E show examples of deflections of electron beams to an anode that correspond to light emitting periods according to the driving voltage of FIG. 7.

For better understanding and ease of description of an exemplary embodiment, four rows of light emission scan lines S₁ to S₄ are illustrated in FIG. 7. A plurality of light emitting pixels EPX corresponding to one row of the light emission unit also corresponds to one of the light emission scan lines. Each of the light emission scan lines has a corresponding light emission scan period, which is divided into five light emitting periods e1 to e5. The light is sequentially emitted in the light emitting periods e1 to e5 according to the corresponding deflection of the electron beams emitted from the electron emission units 41.

Referring to FIG. 7, the light emission scan driver 110 sequentially applies the light emission scan signal to the light emission scan lines S₁ to S₄. In addition, during the respective light emission scan periods T1 to T4 for application of the light emission scan signal, the deflection electrode driver 150 controls the deflection voltages applied to the deflection electrodes 46 and 47 that are adjacent to the light emission scan lines S₁ to S₄ to which the light emission scan signal is applied. In this embodiment, the absolute values of the deflection voltages applied to the deflection electrodes 46 and 47 are kept substantially the same throughout, though their polarities are reversed. These deflection voltages are changed to cause sequential deflections of the electron beams to the anode 51 that correspond to the light emitting periods e1 to e5.

When the electron beams deflect to an anode 51 with a deflection that corresponds to one of the light emitting periods e1 and e5 according to an exemplary embodiment of the present invention, deflection voltages Vd1 and −Vd1 applied to the deflection electrodes 46 and 47 are opposite in polarity and have maximum deflection voltages, for example +500V and −500V, for maximally deflecting the electron beams. When the electron beams deflect to an anode 51 with a deflection that corresponds to one of the light emitting periods e2 and e4, deflection voltages Vd2 and −Vd2 applied to the deflection electrodes 46 and 47 have an absolute value that is smaller than that of the deflection voltages Vd1 and −Vd1, for example +250V and −250V. In light emitting period e3, deflection voltages applied to the deflection electrodes 46 and 47 have the minimum deflection voltage, for example 0V, for perpendicular application (substantially no deflection) of the electron beams to the anode 51.

In addition, when the deflection of the electron beams gradually changes from the light emitting period e1 to the light emitting period e3 or from the light emitting period e3 to the light emitting period e5, voltages applied to the deflection electrodes 46 and 47 have values between the deflection voltages Vd1 and −Vd1 and are opposite in polarity. In this embodiment, the voltages have substantially the same absolute value. That is, during a period of application of the light emission ON voltage Von, a deflection voltage Vd1 of a positive polarity is gradually decreased to a deflection voltage −Vd1 of a negative polarity while being transmitted to the deflection electrode 46, and a deflection voltage −Vd1 of a negative polarity is gradually increased to a deflection voltage Vd1 having a positive polarity while being transmitted to the deflection electrode 47. In this case, the deflection voltages Vd1 and −Vd1 transmitted to the deflection electrodes 46 and 47 have the same absolute value.

The deflection voltages Vd1 and Vd2 and the deflection voltages −Vd1 and −Vd2 applied to the deflection electrodes 46 and 47 are opposite in polarity with reference to the ground voltage (0V) voltage according to an exemplary embodiment of the present invention, but the present invention is not limited thereto. Therefore, the deflection voltages Vd1, Vd2, −Vd1, and −Vd2 applied to the deflection electrodes 46 and 47 may respectively have a predetermined difference from each other in the same polarity for deflection of the electron beams. The deflection voltages for deflection of the electron beams to the anode 51 that corresponds to the light emitting periods e1 to e5 are set to Vd1, Vd2, 0V, −Vd1, and −Vd2 according to an exemplary embodiment of the present invention, but the present invention is not limited thereto. The deflection voltages may be set to be different from each other according to light emitting periods for deflection of the electron beams.

In further detail, referring to FIG. 7 and FIG. 8A to FIG. 8E, when the light emission scan signal is applied to the light emission scan line S₁ and a plurality of light emission data voltages are applied to the plurality of light emission data lines C₁ to C_{q}, a plurality of electron emission units 41 emit electron beams corresponding to voltage differences between a light emission ON voltage Von applied to the light emission scan line S₁ and the light emission data voltages applied to the plurality of light emission data lines C₁ to C_{q}.

In this embodiment, during the light emission scan period T1 of the application of the light emitting scan On voltage Von to the light emission scan line S₁, the deflection electrode driver 150 applies the deflection voltage Vd1 of a positive polarity to the deflection electrode 46 that is adjacent to the light emission scan line S₁ and applies the deflection voltage −Vd1 of a negative polarity to the deflection electrode 47 for light emission in the light emitting period e1 according to the deflection control signal DF from the light emission controller 140, as shown in FIG. 8A. Then, the electron beams emitted from the electron emission units 41 are deflected in a direction of the deflection electrode 46 to which the deflection voltage Vd1 is applied due to a potential difference of the deflection voltages Vd1 and −Vd1 applied to the deflection electrodes 46 and 47. That is, the electron beams are deflected in a direction of the anode 51 that corresponds to the light emitting period e1 for light emission in the light emitting period e1.

Referring next to FIG. 8B, for light emission in the light emitting period e2, the deflection electrode driver 150 applies the deflection voltage Vd2 of a positive polarity to the deflection electrode 46 that is adjacent to the light emission scan line S₁ and applies the deflection voltage −Vd2 of a negative polarity to the deflection electrode 47. In this embodiment, the absolute value of the deflection voltage Vd2 is smaller than the absolute value of the deflection voltage Vd1, and the absolute value of the deflection voltage −Vd2 is smaller than the absolute value of the deflection voltage −Vd1. Then, the electron beams emitted from the electron emission units 41 are deflected in the direction of the deflection electrode 46 to which the deflection voltage Vd2 is applied due to a potential difference of the deflection voltages Vd2 and −Vd2 applied to the deflection electrodes 46 and 47. That is, the electron beams are deflected in the direction of the anode 51 that corresponds to the light emitting period e2 for light emission in the light emitting period e2.

Referring now to FIG. 8C, in light emitting period e3 in which light is emitted with perpendicular application (that is, substantially no deflection) of the electron beams to the anode 51, the deflection electrode driver 150 applies a deflection voltage, for example the ground voltage (0V), which has an absolute voltage that is lower than the absolute values of the deflection voltages Vd2 and −Vd2 to the deflection electrodes 46 and 47 that are adjacent to the light emission scan line S₁. Then, electron beams emitted from the electron emission units 41 travel to the anode 51 in the perpendicular direction so that the light is perpendicularly emitted in the light emitting period e3 by the electron emission units 41.

Referring now to FIG. 8D, since the electron beams deflected in the light emitting period e4 should be symmetrical to the electron beams deflected in the light emitting period e2, the deflection electrode driver 150 applies the deflection voltages −Vd2 and Vd2 that are the same voltages as applied to the deflection electrodes 46 and 47 but are opposite in polarity for light emission in the light emitting period e2. That is, the deflection electrode driver 150 applies the deflection voltage −Vd2 of a negative polarity to the deflection electrode 46 that is adjacent to the light emission scan line S₁ and applies the deflection voltage Vd2 of a positive polarity to the deflection electrode 47. Then, the electron beams emitted from the electron emission units 41 are deflected in a direction that is symmetrical to a direction of the electron beams deflected in the light emitting period e2, that is, a direction of the deflection electrode 47 to which the deflection voltage Vd2 is applied. In other words, the electron beams are deflected in a direction of the anode 51 that corresponds to the light emitting period e4 for light emission in the light emitting period e4.

Referring in a similar manner to FIG. 8E, since the electron beams deflected in the light emitting period e5 should be symmetrical to the electron beams deflected in the light emitting period e1, the deflection electrode driver 150 applies the deflection voltages −Vd1 and Vd1 that are the same voltages as applied to the deflection electrodes 46 and 47 but are opposite in polarity for light emission in the light emitting period e1. That is, the deflection electrode driver 150 applies the deflection voltage −Vd1 of a negative polarity to the deflection electrode 46 that is adjacent to the light emission scan line S₁ and applies the deflection voltage Vd1 of a positive polarity to the deflection electrode 47. Then, the electron beams emitted from the electron emission units 41 are deflected in a direction that is symmetrical to a direction of the electron beams deflected in the light emitting period e1, that is, a direction of the deflection electrode 47 to which the deflection voltage Vd1 is applied. In other words, the electron beams are deflected in a direction of the anode 51 that corresponds to the light emitting period e5 for light emission in the light emitting period e5.

In a manner like the above, during the light emission scan periods T2 to T4, the deflection electrode driver 150 controls voltages applied to the respective deflection electrodes 46 and 47 that are respectively adjacent to the light emission scan lines S₂ to S₄ so that the respective light emitting periods e1 to e5 of the light emission scan periods T2 to T4 can sequentially emit light.

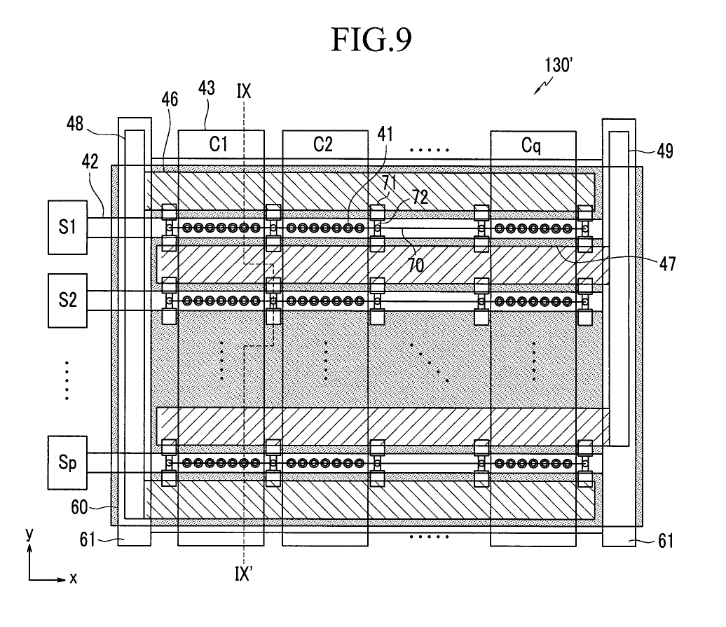

Hereinafter, referring to FIGS. 9 to 12, a light emission unit of a light emitting device according to another exemplary embodiment of the present invention will be described.

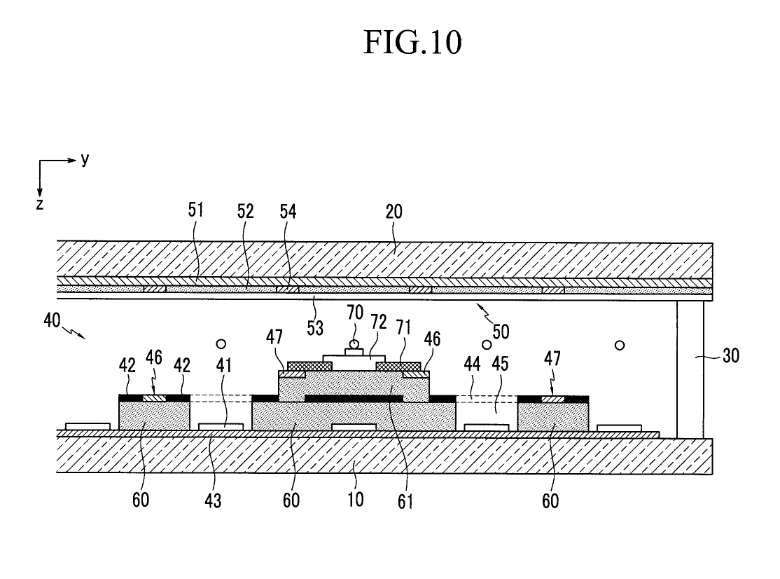

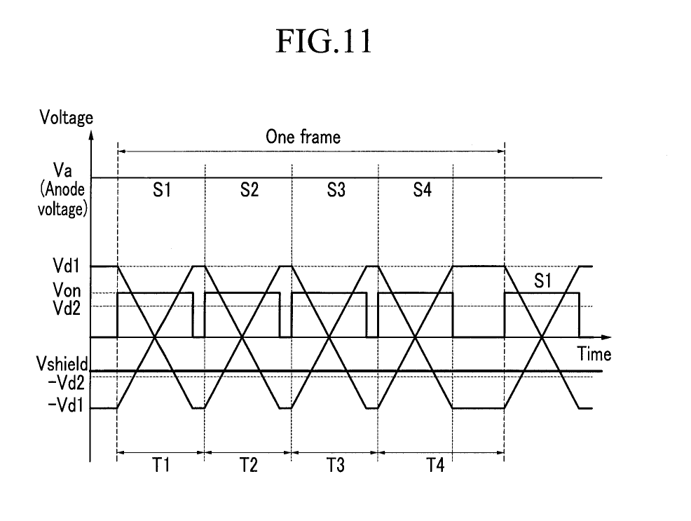

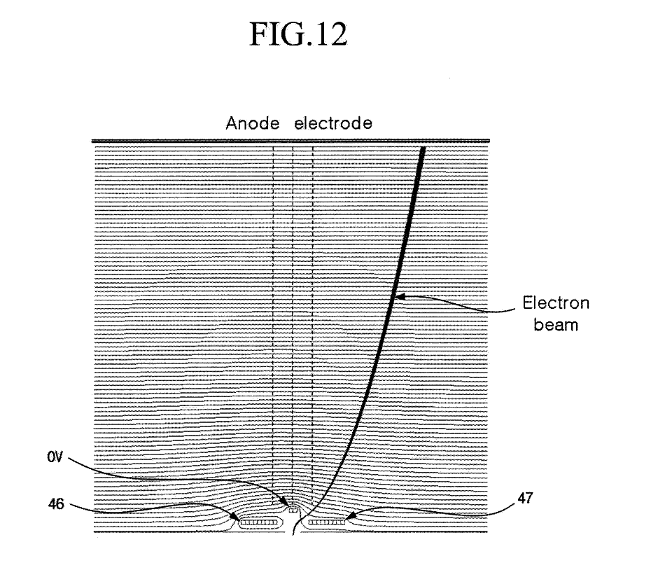

FIG. 9 shows a partial cross-sectional view of a light emission unit of a light emitting device according to another exemplary embodiment of the present invention, and FIG. 10 shows a partial cross-sectional view of the light emission unit of FIG. 9, taken along the line IX-IX′. FIG. 11 schematically shows a driving voltage of the light emission unit of FIG. 9. As in FIG. 7, for ease of understanding, four rows of light emission scan lines S₁ to S₄ are illustrated in FIG. 11. FIG. 12 shows deflection of electron beams from the light emission unit of FIG. 9.

Referring to FIG. 9 and FIG. 10, a light emission unit 130′ according to the current exemplary embodiment of the present invention includes shield electrodes 70 for deflection of electron beams by using a voltage that is lower than voltages applied to the deflection electrodes 46 and 47 of the light emission unit 130.

Unlike the light emission unit 130, the light emission unit 130′ further includes the insulation layer 61 formed on the insulation layer 60, resistance layers 71 formed on the deflection electrodes 46 and 47, and middle electrodes 72 interposed between the resistance layers 71 and the shield electrodes 70 as a conductive layer for electrical contact.

The resistance layers 71 connect the deflection electrodes 46 and 47, and are formed in the y-axis direction between respective light emission data lines C₁ to C_{q}.

The shield electrodes 70 are formed in an upper portion corresponding to electron emission units 41 arranged in a row direction, and extend in the x-axis direction on the middle electrodes 72 between the respective resistance layers 71. Here, a shield voltage Vshield is applied to the shield electrodes 70 for preventing electron beams from being emitted regardless of any light emission scan signals sent to light emission scan lines S₁ to Sₚ. In this embodiment, the shield voltage Vshield should be set within a range that can prevent emission of the electron beams, and therefore it may be set to the ground voltage (i.e., 0V) or a voltage lower than the ground voltage, but the present invention is not limited thereto.

Referring to FIG. 9 and FIG. 11, the light emission scan driver 110 sequentially applies the light emission scan signal to the light emission scan lines S₁ to S₄ among the light emission scan lines S₁ to Sₚ. In addition, during the respective light emission scan periods T1 to T4 for application of the light emission scan signal, the deflection electrode driver 150 applies the deflection voltages Vd1 and −Vd1 to the deflection electrodes 46 and 47 that are adjacent to the respective light emission scan lines S₁ to S₄ to which the light emission ON voltage Von of the light emission scan signal is applied. In this embodiment, the shield electrodes 70 correspond to the light emission scan lines S₁ to S₄. By default, the shield electrodes are applied with the shield voltage Vshield. Then, the shield electrode 70 and the middle electrodes 72 corresponding to each of the light emission scan lines S₁ to S₄ to which the light emission ON voltage Von is applied, is applied with a voltage that corresponds to an average voltage of the deflection voltages Vd1 and −Vd1, and emitted electron beams are deflected according to a difference between the deflection voltages Vd1 and −Vd1.

In the same manner as above, electron beams can be deflected by applying the deflection voltages Vd2, −Vd2, and 0V to the deflection electrodes 46 and 47 that are adjacent to the respective light emission scan lines S₁ to S₄ to which the light emission ON voltage Von is applied. A process for deflection of electron beams in the light emission unit 130′ according to the current exemplary embodiment of the present invention is the same as the process of the previously described exemplary embodiment of the present invention, excluding that the light emission unit 130′ deflects the electron beams by applying to the shield electrodes 72 an average voltage of deflection voltages applied to the deflection electrodes 46 and 47.

As described, the light emission unit 130′ according to the current exemplary embodiment of the present invention can deflect the electron beams as shown in FIG. 12 by using a voltage that is lower than the voltage applied to the deflection electrodes 46 and 47 of the light emission unit 130.

A display device, for example a liquid crystal display (LCD) device that uses the above-described light emitting device as a light source, will now be described in further detail.

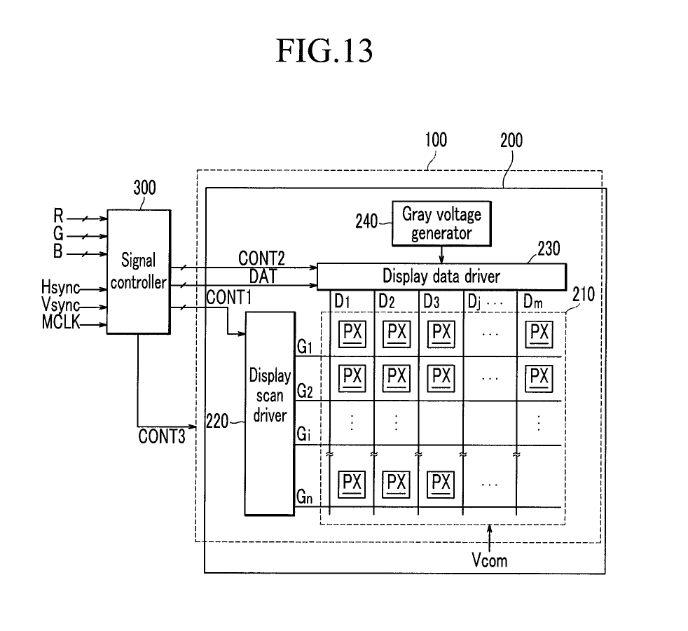

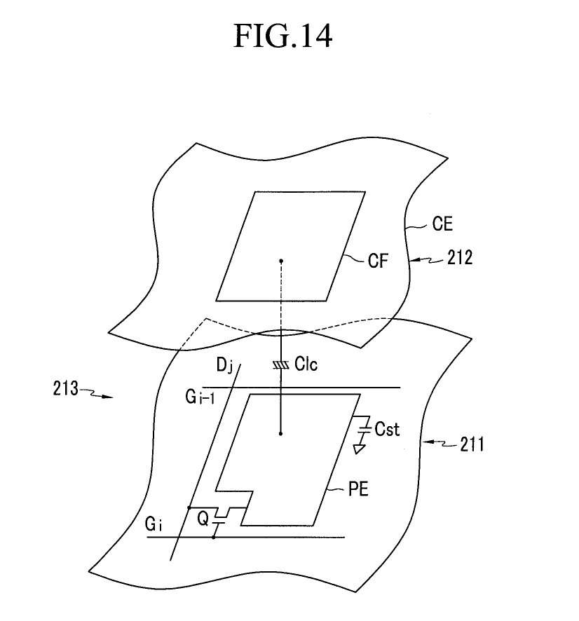

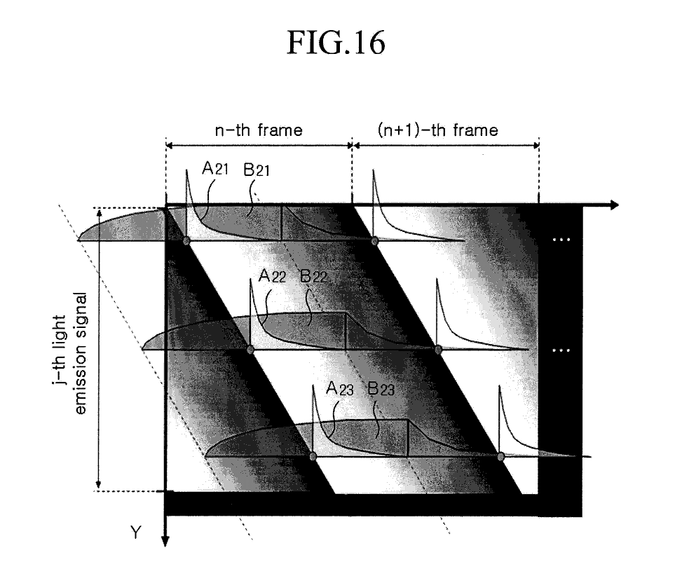

FIG. 13 is a block diagram of an LCD display according to an exemplary embodiment of the present invention, and FIG. 14 is an equivalent circuit diagram of a display pixel of the LCD display according to the present exemplary embodiment. FIG. 15 shows a time point of light supply when a conventional light emitting device is used as a light source, and FIG. 16 shows a time point of light supply according to deflection of electron beams when the light emitting device according to an exemplary embodiment of the present invention is used as a light source.

As shown in FIG. 13, the display device includes a light emitting device 100, a display unit 200, and a signal controller 300, and the display unit 200 includes a display panel 210, a display scan driver 220, and a display data driver 230 connected to the display panel 210, and a gray voltage generator 240 connected to the display data driver 230.

From the view of an equivalent circuit, the display panel 210 includes a plurality of display signal lines G₁ to Gₙ and D₁ to Dₘ, and a plurality of display pixels PX connected to the signal lines and arranged substantially in a matrix format. The display signal lines G₁ to Gₙ and D₁ to Dₘ include a plurality of display scan lines G₁ to Gₙ substantially parallel to a first direction that transmit display scan signals, and a plurality of display data lines D₁ to Dₘ substantially parallel to a second direction and crossing the plurality of data scan lines) that transmit display data signals, that is, display data voltages.

Referring to FIG. 14, each display pixel PX, for example a display pixel PX connected to the i-th (i=1, 2, . . . n) display scan line Gᵢ and the j-th (j=1, 2, . . . m) display data line Dⱼ, includes a switch Q connected to the display signal lines Gᵢ and Dⱼ, along with a liquid crystal capacitor Clc and a sustain capacitor Cst connected to the switch Q. The sustain capacitor Cst may be omitted as necessary.

The switch Q is a three-terminal element such as a thin film transistor provided on a lower display panel 211. A control terminal of the switch Q is connected to the display scan Gᵢ, an input terminal is connected to the display data line Dⱼ, and an output terminal is connected to the liquid crystal capacitor Clc and the sustain capacitor Cst.

A common electrode CE on an upper display panel 212 and a pixel electrode PE on the lower display panel 211 function as terminals of the liquid crystal capacitor Clc, and a liquid crystal layer 213 between the two electrodes PE and CE functions as a dielectric material. The pixel electrode PE is connected to the switch Q, and the common electrode CE is formed on the front side of the upper display panel 212 and applied with a common voltage Vcom. In another embodiment, the common electrode CE may be formed on the lower display panel 211, and in this embodiment, at least one of the two electrodes PE and CE may be linearly shaped or bar-shaped.

The sustain capacitor Cst that supplements the liquid crystal capacitor Clc is formed such that an additional signal line (not shown) provided in the upper display panel 212 and the pixel electrode PE overlap with an insulating material interposed therebetween, and the additional signal line is applied with a predetermined voltage such as a common voltage Vcom. In other embodiments, the storage capacitor Cst may be formed by overlapping the pixel electrode PE on a previous scan line with the insulating material therebetween.

In order to perform color display, each display pixel PX specifically displays one of the primary colors (spatial division) or the display pixels PX alternately display the primary colors over time (temporal division), such that the primary colors combine spatially or temporally, thereby displaying a desired color. The primary colors may include red, green, and blue. In spatial division, three display pixels, respectively representing red, green, and blue, may form a dot that is a primary unit of an image. As an example of the spatial division, FIG. 14 shows that each display pixel PX has a color filter CF for displaying one of the primary colors in a region of the upper display panel 212. Unlike the structure shown in FIG. 14, the color filter CF may be provided above or below the pixel electrode PE of the lower display panel 211.

At least one polarizer (not shown) for polarizing light is mounted on the display panel 210.

Referring back to FIG. 13, the display scan driver 220 is connected with the display scan lines G₁ to Gₙ of the display panel 210, and applies display scan signals formed of a combination of a scan ON voltage and a scan OFF voltage to the display scan lines G₁ to Gₙ.

The display data driver 230 is connected with display data lines D1 to Dm of the display panel 210, and selects gray voltages from the gray voltage generator 240 and applies the selected gray voltages as data signals to the data lines D1 to Dm. However, when the gray voltage generator 240 provides a predetermined number of reference gray voltages rather than providing voltages for all grays, the display data driver 230 generates other gray voltages for other grays by using the reference gray voltages.

The gray voltage generator 240 generates all gray voltages related to luminance of the display pixel PX or a limited number of gray voltages (hereinafter referred to as reference gray voltages).

The signal controller 300 controls the display scan driver 220, the display data driver 230, and the light emitting device 100. The signal controller 300 receives input video signals R, G, and B and input control signals for controlling the input video signals from an external graphics controller (not shown). The input video signals R, G, and B include luminance information of each display pixel PX, and the luminance has a predetermined number, for example 1024=2¹⁰, 256=2⁸, or 64=2⁶, of grays. The input control signal exemplarily includes a vertical synchronization signal Vsync, a horizontal synchronization signal Hsync, and a main dock signal MCLK.

The signal controller 300 properly processes the input video signals R, G, and B for an operation condition of the display panel 210 on the basis of the input video signals R, G, and B and the input control signals, generates a scan control signal CONT1, a data control signal CONT2, and a light emitting device control signal CONT3, and transmits the scan control signal CONT1 to the display scan driver 220, transmits the data control signal CONT2 and the processed video signal DAT to the display data driver 230, and transmits the light emitting device control signal CONT3 to the light emission controller 140. For interacting of the light emission operation of the light emitting device 100 and the display operation of the display device 200, the light emitting device control signal CONT3 may include signals that correspond to the video signal DAT, the scan control signal CONT1, and the data control signal CONT2.

The display operation of the LCD will now be described in further detail. In this example, the LCD uses a light emitting device that includes the light emission unit 130 according to an exemplary embodiment of the present invention as a light source.

Referring to FIG. 2 and FIG. 13, the display data driver 230 receives the digital video signal DAT for the display pixels PX of one row according to the data control signal CONT2 from the signal controller 300, selects gray voltages corresponding to each digital video signal DAT to thereby convert the digital video signal DAT to analog data voltages, and then applies the analog data voltages to the corresponding display data lines D₁ to Dₘ.

The display scan driver 220 applies the scan ON voltage to the display scan lines G₁ to Gₙ according to the scan control signal CONT1 from the signal controller 300 to turn on the switch Q connected to the display scan lines G₁ to Gₙ. Then, the data voltages applied to the display data lines D₁ to Dₘ are applied to the corresponding display pixels PX through the turned-on switch Q.

In this embodiment, the light emission controller 140 transmits the light emitting scan control signal CS, the light emitting data control signal CD, and the deflection control signal DF, respectively, to the light emission scan driver 110, the light emission data driver 120, and the deflection electrode driver 150 for light emission of light emitting pixels EPX of one row that corresponds to the display pixels PX of the corresponding row or rows according to the light emitting device control signal CONT3 from the signal controller 300.

The light emission scan signals are sequentially applied to the light emission scan lines S₁ to Sₚ according to the light emitting scan control signal CS, and a plurality of light emission data voltages are applied to a plurality of light emission data lines C₁ to C_{q} according to the light emitting data control signal CD so that electron beams are emitted from the electron emission units 41. In this embodiment, during a period of application of the light emitting scan ON voltage Von, the deflection electrode driver 150 controls voltages of deflection electrodes 46 and 47 that are adjacent to the light emission scan lines to which the light emission scan signal is applied to thereby deflect the electron beams. That is, for each light emission scan period of a corresponding light emitting pixel row, the deflection electrode driver 150 sequentially deflects electron beams for at least one light emitting period of the light emission scan period, where each light emitting period corresponds to a different deflection of the electron beams and a different display pixel row of the display pixel rows that correspond to the light emitting pixel row. Thus, the data voltage is applied to a display pixel PX of a row that corresponds to the light emitting period so that light can be supplied corresponding to a response time of the liquid crystal layer 213.

A difference between the data voltage applied to the display pixel PX and the common voltage Vcom is represented as a charged voltage of the liquid crystal capacitor Clc, that is, a pixel voltage. Alignment of liquid crystal molecules varies according to the size of the pixel voltage, and polarization of light that transmits through the liquid crystal layer 213 changes accordingly. Such change in the polarization appears as a change in transmittance of light by the polarizer attached on the liquid crystal panel assembly 300, whereby the display pixels PX display luminance expressed by the gray level of the video signal DAT.

The process is repeatedly performed by the unit of one horizontal period (which may be equivalent to one period of a horizontal synchronization signal Hsync) in order to sequentially apply the scan ON voltage to all display scan lines G₁ to Gₙ and the data voltage to all display pixels PX to thereby display an image of one frame. In addition, when there are N display rows corresponding to each light emitting row, the light emitting device 100 repeats this process as N times the number of light emission scan period units of one horizontal period. That is, the light emitting device 100 can supply light to the display panel 210 while the display panel 210 displays an image of one frame, by repeating the process of emitting light from the light emitting pixels EPX of one row in response to the display pixels PX of N rows.

As described, since electron beams are deflected for at least one light emitting period of the light emission scan period corresponding to one row of light emitting pixels EPX according to an exemplary embodiment of the present invention, the light emitting device can supply light corresponding to a response time at which a corresponding row of display pixels PX corresponding to the light emitting period is applied with the data voltage and the liquid crystal layer 213 responds thereto.

For example, when an image to be displayed in one frame is changed from black to white, as shown in FIG. 15, the light emitting unit having a conventional light emitting device as a light source emits electron beams so that times A₁₁ to A₁₃ for supplying light to the j-th light emitting signal Sⱼ and response times B₁₁ to B₁₃ of liquid crystal at the time that the black image is changed to the white image do not match, thereby causing luminance non-uniformity. However, as shown in FIG. 16, electron beams emitted from the light emitting unit having the light emitting device according to an exemplary embodiment of the present invention as a light source are deflected so times A₂₁ to A₂₃ for supplying light to the j-th light emitting signal Sⱼ and response times B₂₁ to B₂₃ of liquid crystal at the time that the black image is changed to the white image match, thereby preventing luminance non-uniformity.

Therefore, the display device having the light emitting device according to an exemplary embodiment of the present invention can prevent non-uniformity of luminance that can occur due to mismatching of the time that light is emitted from the light emitting pixel and the time that light is transmitted by operation of the liquid crystal of the display pixel.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A light emitting device comprising;
a plurality of light emission scan lines extending in a first direction, the light emission scan lines for transmitting light emission scan signals;
a plurality of light emission data lines extending in a second direction that crosses the plurality of light emission scan lines, the light emission data lines for transmitting light emission data voltages;
a plurality of light emitting pixels at areas defined by the plurality of light emission scan lines and the plurality of light emission data lines, the light emitting pixels for emitting electrons according to differences between an on voltage of the light emission scan signals and the light emission data voltages; and
first and second deflection electrodes parallel with each other in the first direction between the plurality of light emitting pixels,
wherein an absolute value of a first voltage applied to the first deflection electrode and an absolute value of a second voltage applied to the second deflection electrode are set according to a deflection direction of the electrons.

2. The light emitting device of claim 1, wherein a light emission scan period corresponding to the on voltage being transmitted on a light emission scan line of the plurality of light emission scan lines, is divided into at least one light emission period, and the corresponding plurality of light emitting pixels are adapted to sequentially emit light during the at least one light emission period according to absolute values of the first and second voltages.

3. The light emitting device of claim 1, wherein, during a period in which the on voltage of the light emission scan signals is applied to one of the plurality of light emission scan lines, the absolute value of the first voltage is the same as that of the second voltage.

4. The light emitting device of claim 3, wherein when a sum of the absolute value of the first voltage and the absolute value of the second voltage is a minimum value, the electrons are perpendicularly applied rather than being deflected.

5. The light emitting device of claim 1, wherein the plurality of light emission scan lines comprise first electrodes, the plurality of light emission data lines comprise second electrodes, and the plurality of light emitting pixels comprise a plurality of electron emission units on one of the first electrodes and the second electrodes in areas where the first electrodes and the second electrodes cross each other.

6. The light emitting device of claim 5, wherein the first and second deflection electrodes are adapted to deflect the electrons emitted from the plurality of electron emission units formed between the first and second deflection electrodes.

7. The light emitting device of claim 5, further comprising:
resistance layers extending in the second direction and electrically connecting the first and second deflection electrodes to each other;
a shield electrode extending in the first direction above and between the resistance layers, that corresponds to a plurality of electron emission units in the first direction; and
a middle electrode formed between the resistance layers and the shield electrode for contact therebetween.

8. A display device comprising:
a display panel comprising a plurality of display scan lines extending in a first direction and for transmitting display scan signals, a plurality of display data lines extending in a second direction that crosses the plurality of display scan lines and for transmitting display data signals, and a plurality of display pixels at areas defined by the plurality of display scan lines and the plurality of display data lines; and
a light emitting device comprising a plurality of light emission scan lines extending in the first direction and for transmitting light emission scan signals, a plurality of light emission data lines extending in the second direction and for transmitting light emission data voltages, a plurality of light emitting pixels at areas defined by the plurality of light emission scan lines and the plurality of light emission data lines and for emitting electrons according to differences between an on voltage of the light emission scan signals and the light emission data voltages, and first and second deflection electrodes parallel with each other in the first direction between the plurality of light emitting pixels,
wherein an absolute value of a first voltage applied to the first deflection electrode and an absolute value of a second voltage applied to the second deflection electrode are set according to a deflection direction of the electrons, and
wherein a light emission scan line of the plurality of light emission scan lines corresponds to a group of a predetermined number of display scan lines of the plurality of display scan lines.

9. The display device of claim 8, wherein a light emission scan period corresponding to the on voltage being transmitted on the light emission scan line is divided into light emitting periods corresponding to the group of display scan lines, and the corresponding plurality of light emitting pixels are adapted to sequentially emit light during the light emitting periods according to the absolute values of the first and second voltages.

10. The display device of claim 8, wherein, during a period in which the on voltage of the light emission scan signals is applied to one of the plurality of light emission scan lines, the absolute value of the first voltage is the same as that of the second voltage.

11. The display device of claim 10, wherein when a sum of the absolute value of the first voltage and the absolute value of the second voltage is a minimum value, the electrons are perpendicularly applied rather than being deflected.

12. The display device of claim 8, wherein the plurality of light emission scan lines comprise first electrodes, the plurality of light emission data lines comprise second electrodes, and the plurality of light emitting pixels comprise a plurality of electron emission units on one of the first electrodes and the second electrodes in areas where the first electrodes and the second electrodes cross each other.

13. The display device of claim 12, wherein the first and second deflection electrodes are adapted to deflect the electrons emitted from the plurality of electron emission units formed between the first and second deflection electrodes.

14. The display device of claim 12, further comprising:
resistance layers extending in the second direction and electrically connecting the first and second deflection electrodes to each other;
a shield electrode extending in the first direction above and between the resistance layers, that corresponds to a plurality of electron emission units in the first direction; and
a middle electrode formed between the resistance layers and the shield electrode for contact therebetween.

15. A driving method of a display device that includes a plurality of first electrodes extending in a first direction and for transmitting first signals comprising combinations of an on voltage and an off voltage, a plurality of second electrodes insulated from and crossing the first electrodes and for transmitting light emission data voltages, a plurality of electron emission units at crossing areas of the plurality of first electrodes and the plurality of second electrodes, and first and second deflection electrodes parallel with each other in the first direction between the plurality of electron emission units, comprising:
transmitting the on voltage to at least one first electrode of the plurality of first electrodes;
transmitting a light emission data voltage of the light emission data voltages to at least one of the plurality of second electrodes;
while the on voltage is applied to the at least one first electrode, setting an absolute value of a first voltage applied to the first deflection electrode and an absolute value of a second voltage applied to the second deflection electrode;
emitting electrons according to a difference between the on voltage and the light emission data voltage; and
deflecting the electrons by using the absolute values of the first and second voltages.

16. The driving method of claim 15, wherein the setting of the absolute values of the first and second voltages comprises setting the absolute value of the first voltage to be equal to the absolute value of the second voltage while the on voltage is applied to the at least one first electrode.
